(19) United States
(12) Patent Application Publication
(10) Pub. No.: US 2007/0056086 A1
(43) Pub. Date: Mar. 15, 2007

(54) Toilet Seat Gap Shield

(76) Inventor: Thekkeurimbil Raviendran, Lone Tree, CO (US)

Correspondence Address: KYLE W. ROST, 5490 AUTUMN CT., GREENWOOD VILLAGE, CO, 80111, US

(21) Appl. No.: 11/162,490

(22) Filed: Sep. 12, 2005

(51) Int. Cl. E03D 9/00; F15D 1/00

(52) U.S. Cl. 4/300.3

(57) ABSTRACT

A toilet defines an open topped bowl and carries a toilet seat ring with a central opening that aligns with the open topped bowl. A shield is joined to the bottom of the seat ring, positioned at the front inner edge of the seat ring, such that the shield covers any gap between the seat and the bowl from inside the bowl. The shield may be integrally formed with the toilet seat ring or separately formed and later attached. A separately formed shield includes an arcuate shield wall and fastening wall extending from one face of the shield wall, i.e., the convex face. The fastening wall establishes a planar surface for attachment against the bottom of the seat ring. The arc of the shield wall is conformable to the arc of the seat ring without distorting the plane of the fastening wall.

### BACKGROUND OF THE INVENTION

1. Field of the Invention

The invention generally relates to baths, closets and sinks. More specifically, the invention relates to a flush closet with a splash guard or water baffle. The invention is a shield mounted to a toilet seat in a suitable position to cover the gap between a toilet seat and toilet bowl.

2. Description of Related Art Including Information Disclosed Under 37 CFR 1.97 and 1.98

Devices associated with a standard toilet are designed to contain and control splashing and splattering, typically caused by males who stand while urinating. The most common device is the raisable toilet seat. The seat is raised primarily to remove it from the area of the bowl rim while a male urinates from a standing position. In raised position, the seat surface is protected from splashes because the seating surface is facing away from the toilet bowl. Such splashes as may occur from the bowl largely are confined to the opposite or bottom face of the seat. The seating surface remains reasonably clean for subsequent usage by a seated user.

U.S. Pat. No. 5,625,905 to Woods provides an additional protection against splattering near the toilet bowl. Once again the standing male presents the problem, but in this instance, the concern is that urine will splash on the rim and inner face of the bowl, itself. The proposed solution is a plastic deflector that covers the rim, and a depending flange covers the upper inside edge of the bowl. Another part of the deflector covers the hinge of the raised toilet seat. Of course, this deflector is splashed upon in simple substitution from other parts of the toilet and seat. The advantage realized is that the deflector easily can be removed for cleaning.

A related problem has not been addressed. Conventionally, a toilet bowl carries the toilet seat by three or more point support. The seat is hinged to the rear edge of the bowl, and the hinge can be regarded as one point of support. The bottom face of the seat carries two or more bumpers or spacers, which can be regarded as two or more additional points of support. These various elements space the seat from the bowl rim by creating a gap. The gap tends to be substantial enough that liquids readily can enter and pass through the gap. Hence, the related problem is that a stream of urine even from a seated user can strike the front of the bowl at the gap, where it can travel through the gap and out the front of the toilet.

It would be desirable to shield the gap under a toilet seat from inside the toilet bowl, so that misdirected urine from a seated user does not enter the gap.

To achieve the foregoing and other objects and in accordance with the purpose of the present invention, as embodied and broadly described herein, the method and apparatus of this invention may comprise the following.

### BRIEF SUMMARY OF THE INVENTION

Against the described background, it is therefore a general object of the invention to provide a shield that protects the gap between a toilet seat and a toilet bowl from entry by misdirected urine of a seated user.

Another object is to provide a shield that is connected to or movable with a toilet seat, so that the shield achieves a secure seal with the toilet seat.

A further object is to provide a shield positioned, in use, at the inside face of the toilet bowl so that liquids cannot enter the gap between the seat and bowl.

According to one aspect of the invention, a toilet seat gap shield is formed of a shield wall that is configured as an arc. A fastening wall is connected to the shield wall and establishes a planar major face approximately perpendicular to the shield wall. The planar face extends substantially to only the convex side of the arc. An attaching device connects the fastening wall to a toilet seat.

Another aspect of the invention is a toilet seat that includes a hinge at its rear end. A seat ring extends from the hinge. An inner edge of the seat ring defines a central opening. A gap shield depends from the bottom of the seat ring at a front quadrant opposite from the hinge.

The invention addresses a combination of a toilet carrying a toilet seat mounted on it. The toilet defines an open topped bowl having a rim encircling the top opening of the bowl. The toilet seat includes a hinge attaching the seat to the toilet to the rear of the bowl. The toilet seat also includes a seat ring that extends from the hinge and defines a central opening that is bounded by an inner edge of the seat ring. The seat ring is pivots on the hinge to a position overlying the bowl rim, such that the central opening of the seat ring is aligned with the open top of the bowl. A shield joined to the bottom of the seat ring and is positioned juxtaposed to the front inner edge of the seat ring. The shield is in a suitable position to depend from the seat ring and cover a front inside portion of the bowl when the seat ring is in position overlying the bowl rim.

The accompanying drawings, which are incorporated in and form a part of the specification, illustrate preferred embodiments of the present invention, and together with the description, serve to explain the principles of the invention. In the drawings:

### BRIEF DESCRIPTION OF THE SEVERAL VIEWS OF THE DRAWINGS

FIG. 1 is an isometric view of a representative toilet, with bowl and seat partially broken away to show the shield of the invention positioned to defend the gap between the seat and bowl.

FIG. 2 is an isometric view of the bottom face of a toilet seat, showing the preferred position and arc of the shield.

FIG. 3 is an isometric view of the shield attached to the bottom of a toilet seat.

FIG. 4 is a fragmentary view of a cross-sectional face taken at plane 4-4 of FIG. 1, showing a seat, toilet bowl rim, and shield of a first embodiment of the invention.

FIG. 5 is a view similar to FIG. 4, showing a second embodiment of the shield.

FIG. 6 is a view similar to FIG. 4, showing a third embodiment of the shield.

### DETAILED DESCRIPTION OF THE INVENTION

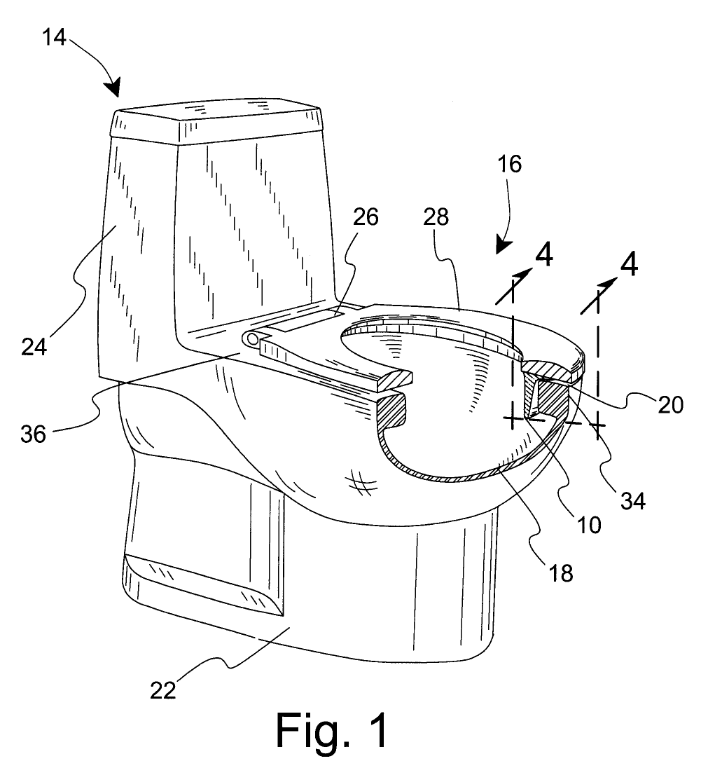

The invention is an apparatus for shielding the inner face of a toilet bowl and toilet seat from entry of liquids into the gap between them. With reference to FIGS. 1-3, the invention is a shield 10 in the form of a shield wall 12 that is applied to a toilet 14 that carries a seat 16. More specifically, the shield wall 12 is applied to, carried by, or a component of the seat 16. The shield wall can be formed of an arc of sheet material, including planar sheet material that is disposed in the shape of an arc. In use, shield 10 occupies a position defined with respect to the seat 16 and the toilet 14 such that the shield covers at least a portion of the inside face of a toilet bowl 18 when the seat is in a lowered or functional position. In this relative position, the shield is enabled to guard against liquids entering a gap 20 typically found between the seat and the bowl.

The view of FIG. 1 illustrates the operating environment for the shield 10. A representative toilet 14 is formed of two subcomponents referred to as the base 22 and a tank 24, with the latter being optional for purposes of the invention. Depending upon details of individual toilet design, the base 22 and tank 24 may be supplied as a one-piece assembly or a two-piece assembly. FIG. 1 illustrates a one-piece assembly, wherein the base 22 and tank 24 are integrated into a single structure. The position of the tank 24 with respect to the base 22 is rigidly fixed such that the tank 24 is nonremovable from the base. In a two-piece toilet structure, the tank 24 is removable from the base 22, although in use the tank 24 typically is held in a fixed, predetermined position with respect to the base 22 in order to maintain a water passage from the tank 24 into the bowl 18 of base 22.

The seat 16 is shaped as a closed geometric figure with the hinge 26 located at a rear end of the closed figure. Seats 16 tend to have a ring-like seat portion 28 forward of the hinge 26, and for convenience of description, the closed geometric figure will be referred to as a seat ring. This descriptive term is non-limiting, as commercially produced seats are known to have various closed geometric shapes such as ovals, ellipses, and even rectangles. Any closed geometric shape of seat is believed suitable for use with the invention. Public toilets are known to have seats with a widely open front edge, but the invention is not directed to such public seats having a widely open front edge. The invention is intended for use with seats having a closed or nearly closed front.

Typically, the seat 16 includes a hinge 26 suited to attach the seat 16 to the base 22. An attachment point for a hinge 26 is located on the base 22 to the rear of the toilet bowl 18, near the attachment or junction between the base 22 and the tank 24. The rearward proximity of the hinge 26 establishes that the seat 16 is raised or lowered on rear hinge 26. The seat is pivotable with respect to base 22 on the hinge 26. The seat 16 can be raised to near-vertical, over-center position, such that the seat 16 rests against the tank 24 or otherwise is supported in similar raised position. A seat 16 also can be moved on hinge 26 to a near-horizontal, lowered position, such that the seat is supported with a bottom seat surface 30 facing toward the base 22, bowl 18, or otherwise in similar lowered position. The seat 16 is configured such that, when the hinge 26 is attached to base 22, the ring-like portion 28 of the seat 16 is approximately centered over the bowl 18 when in lowered position. The raised position is a storage position, while the lowered position is a functional position enabling a user of the toilet to sit on the upper surface 32 or face of the seat ring 28 over the bowl 18.

The base 22 defines a rim 34 around the top of the toilet bowl 18. The base 22 or any other portion of a toilet 14 having fixed position with respect to the base 22 carries the seat 16. The base 22 typically defines a single, substantially planar top surface 36 that is coextensive with the top of the rim 34 and with the mounting area from seat hinge 26. The presence of the single, substantially planar surface 36 that both supports the hinge and encircles the bowl 18 allows a seat 16 to be designed for predictable, predetermined engagement with the base 22. Thus, the hinge 26 establishes a predetermined height between the seat 16 and the plane surface 36 at the position of the hinge 26.

In addition, the seat ring 28 carries bumpers 38 on its bottom face 30 for abutting surface 36 at the rim 34 when the seat is in lowered position. The bumpers 38 establish a gap 20 between the seat ring 28 and the bowl rim 34. Two to four bumpers 38 are used on the bottom face 30 of a seat 16. The bumpers 38 protect the bottom surface 30 of the seat 16 and the rim 34 from mutual abrasion and provide impact damping between the seat 16 and rim 34. The number of bumpers 38 advantageously can be limited to two so that the two bumpers 38 plus the hinge 26 define a plane to provide stable, three-point support against the toilet surface 36. It is suitable to use a greater number of bumpers 38 than two because inherent flexibility in the material of construction of a seat 16 can allow such greater number of bumpers 38 to contribute to supporting the seat 16.

Reference to a seat 16 being positioned or mounted on a base 22 or on the toilet 14 should be construed as allowing the seat 16 to be carried on the base 22, on the tank 24, or on any other structure having a predetermined spatial relationship to the toilet bowl 18, such that the seat 16 can be oriented for functional use with respect to the toilet bowl 18. For convenience of description and not as limitation, seat 16 has been described and illustrated as conventionally attached to a base 22.

Toilet bowls 18 are manufactured in a variety of shapes. Seats 16 are manufactured in matching shapes so that a seat ring 28 will have corresponding shape to overlie the rim 34 of a bowl 18. In particular, a seat ring 28 defines a central opening that is similar in size and shape to the opening within the rim 34 of the toilet bowl 18. Common shapes of the central opening include circular shapes and ovals. The corresponding bowl rim shapes often are referred to as round or oblong, although these terms are approximate.

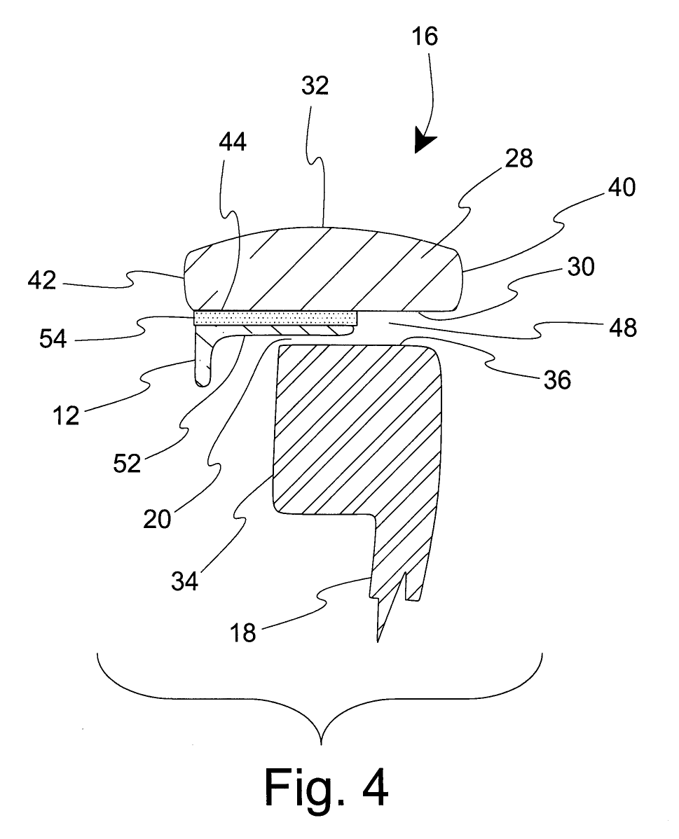

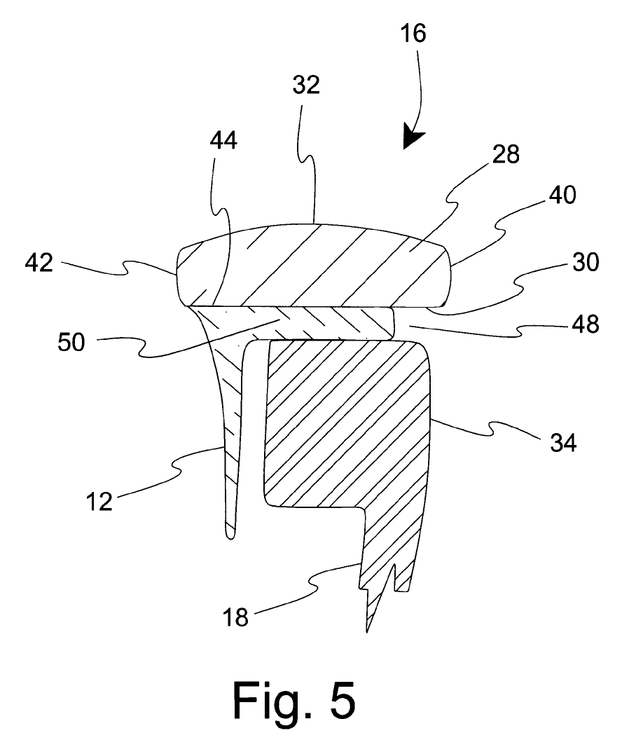

Typically, the seat 16 is sized and configured to match the bowl rim 34 when it overlies the bowl rim 34 such that the seat 16 covers the top surface 36 of the bowl rim 34. A properly fitting seat 16 tends to have an outside peripheral surface 40 that closely matches the outside periphery of the rim 34. Thus, in FIGS. 4 and 5 the outer surface 40 of the seat and the outer face of the rim are similar in lateral position. Small differences in lateral position are of little consequence.

Also typically, the inside face 42 of the seat 16, which defines the inner periphery of the seat ring 28, extends inwardly or centrally from the rim 34 by a substantial dimension. Thus, in FIGS. 4 and 5, the inside face 42 of the seat 16 extends inwardly from rim 34 on an overhanging seat portion 44 that typically has a dimension on the order of one inch. The bottom surface 30 of the seat 16 extends inwardly of the rim 34 by the dimension of this overhang 44. This more substantial extension serves the purpose of compensating for slight misalignments between the seat ring 28 and the bowl rim 18. The greater inner overhang 44 of the seat 16 ensures that a seated user will not be in contact with the rim 34, despite misalignments. The rim 34 tends to be of porcelain, which is cold and uncomfortable to contact. In addition, the rim 34 is likely to be less clean than the seat. Therefore, as a rule, the central opening of a seat 16, defined by seat edge 42, is designed and intended to be smaller than the top opening of the toilet bowl 18.

The shield wall 12 is positioned to take advantage of the overhang 44. The desired position for the shield wall 12 is at a front quadrant of the seat ring 28. With respect to a seat in lowered position, the shield wall 12 depends from the seat ring 28 at the front inward extension of the overhang 44. This depending position ensures that the shield wall 12 can overlap the inner face of the rim 34, if required when the seat 16 is in lowered position. When the seat is in lowered position, the shield wall 12 is approximately vertical and the seat bottom 30 is approximately horizontal. The vertical distance by which the shield wall 12 depends from the bottom 30 of the seat 16 can be referred to as the depth of the shield wall 12. As an example and not a limitation, depths can be as small as one-half inch or as great as two inches.

The shield 10 is adaptable to either oblong or round rim shapes. The shield wall 12 may be formed of planar sheet material that is pre-formed in the shape of an arc with major faces perpendicular to the seat bottom 30. Alternatively, the shield wall may be cast or otherwise produced with a predetermined initial arc. The arc radius may be in the range from about two inches to about eight inches. This range of arc radius is suitable to follow or approximate the contour of the front inside face 42 of many toilet seats 16. Due to variations in the arc of the front inner face 42 between different manufacturers of seats 16, the shield wall 12 also may be flexible so that it can be conformed to other arcs as required. Pre-forming the shield wall 12 into an arc is useful so that the final arc of an applied shield 10 is under minimal deformation stress, which otherwise might tend to loosen an adhesive attachment between the shield wall 12 and a seat 16.

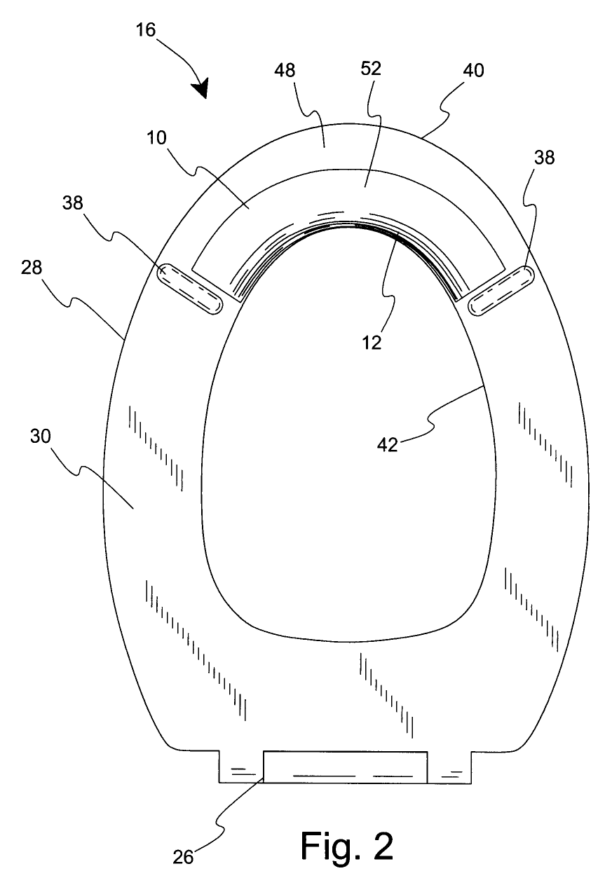

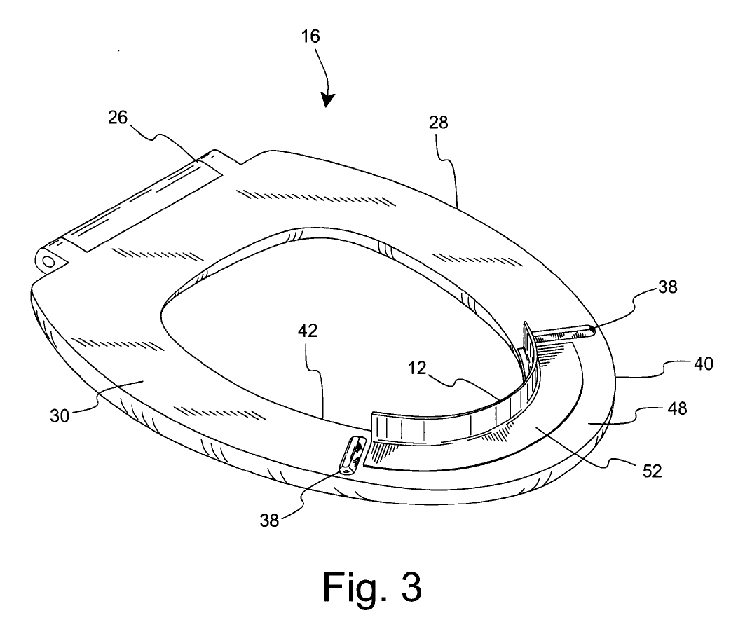

The shield wall 12 is best located to closely follow the contour of the inner face 42 of the seat ring 28. The contour of the front inner edge 42 typically is an arc or similar to an arc. The arc traverses the front of the seat and establishes a side-to-side dimension of the shield 10. An effective limit on the side-to-side dimension of the arc may be the positions of bumpers 38 as shown in FIGS. 2 and 3. Bumpers 38 often are located near the front of a seat, offset from the center in a symmetric arrangement. The arc length of the shield wall 12 may be referred to simply as the length of the shield wall 12.

As an example and not a limitation, as compared to the inner periphery of the seat ring 28, the length of the shield wall 12 is about twenty-five percent of the length of the inner periphery 42, or about a quadrant of the inner periphery 42. The preferred length of the shield 10 can be defined as occupying a substantial portion of a front quadrant of the toilet seat. The remaining quadrants are a rear quadrant, and a pair of opposed side quadrants. The view of FIG. 2 best shows a shield 10 occupying approximately a front quadrant of the toilet seat 16. An approximate minimum length of the shield 10 is about one-third of a quadrant or one-twelfth of the inner periphery of the seat ring 28. By another mode of measurement, the inner periphery of a seat ring 28 often is between thirty-one and thirty-two inches. Thus, a minimum length of a shield 10 is about two and one-half inches. A more preferred length, roughly equivalent to the showing of FIG. 2, is about eight inches. The shield 10 is centered at the front of the seat ring 28, such that about one-half of the length or about one-eighth the inner peripheral length of the shield wall 12 is distributed to each lateral side of the seat front from a centerline thereof.

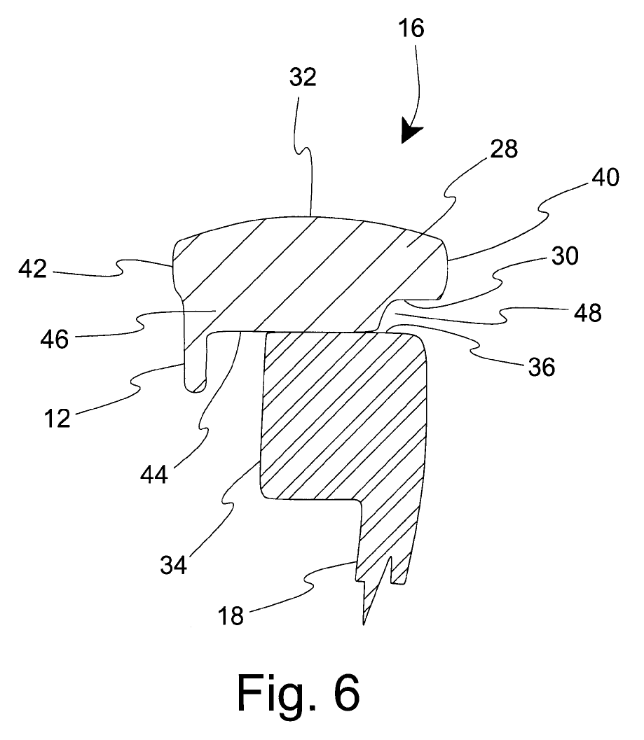

In one embodiment of the invention best shown in FIG. 6, the shield 10 is formed as an integral part of a seat 16. Where seat 16 is molded, such as of a plastic or composite material, the shield 10 is formed with the seat in a single mold. Formed in this way, it may be practical for the shield wall 12 to extend over a substantially greater portion of the inner periphery 42 than the preferred one-quarter. A shield wall 12 may have a length equal to the inner periphery 42 of the seat 16.

As a further feature of such a unitary combination of a seat 16 and a shield 10, the bumpers 38 are optional. In place of bumpers 38, the shield 10 may provide a bumper wall 46 extending from the shield wall 12 toward the outer periphery or outer edge 40 of the seat 16. The bumper wall 46 may terminate before reaching the outer edge 40 of the seat 16. Such termination establishes a finger grip notch 48 on the lower side 30 of the seat 16.

The bumper wall 46 is particularly practical when formed of a suitable material to absorb shock, resist abrasion, and protect the material of toilet surface 36. Thus, plastics, rubberized materials, and composites are suitable choices. The bumper wall 46 may be formed as a laminate employing a different material, or the seat 16 may be formed by a method of curing wherein the bumper wall 46 is of lower harness than a remainder of the seat 16. Where the chosen material is sufficiently yieldable to create a seal with the surface 36, the bumper wall 46 supplements the protective function of the shield wall 12. It is desirable that the bumper wall 46 be limited in its extent of coverage to about the front quadrant of the seat 16. The shield wall 12 can be of minimum depth when supplemented by a bumper wall 46, in part because substantially the entire shield wall 12 depends below the interface of the bumper wall 46 and the toilet rim 34.

FIG. 5 shows an embodiment of the shield 10 in which the shield 10 and seat 16 initially are formed as separate parts that later are combined. The shield 10 is formed of the shield wall 12 that is shaped as an arc or shapeable as an arc. The shield 10 of FIG. 5 can be mounted on the bottom surface 30 of seat 16. A variety of fasteners provide suitable means for attaching the shield 10 to the seat. Friction fasteners such a screws are suitable, as is an adhesive, double sided tape, or mechanical interlock such as a channel formed in the seat 16 to receive the shield 10. The shield can be applied to seats 16 of generic design. For this application, the most suitable connecting means is bonding or adhesion, such as by use of a bonding substance. Various glues, hot melt adhesive, and double-sided tape are preferred choices.

The shield wall 12 is mounted in a vertical, depending positioned from bottom seat surface 30, when the latter is horizontal, such as when the seat 16 is in lowered position. The top end of the shield 10 may form or be joined to a transverse fastening wall 50 that is disposed with a top major face in an approximately horizontal position when the major faces of the shield wall 12 are vertical. Thus, the shield wall 12 and fastening wall 50 are approximately perpendicular to one another. The fastening wall 50 preferably lies substantially to one side of the shield wall 12, which will be the convex side of the arc. In this position, the top major face of the fastening wall 50 can be attached to the bottom surface 30 of the seat 16 while locating the shield wall 12 substantially juxtaposed to or aligned with seat inside edge 42.

The fastening wall 50 serves as an enlarged fastening surface as compared to the relatively narrow top edge of the shield wall 12. The fastening wall 50 may be of a thickness sufficient that the fastening wall 50 functions similarly to the bumper wall 46 of the prior embodiment. A suitable thickness may fall in the range from one-quarter to one-half inch. A typical toilet seat 16 has a width between outer edge 40 and inner edge 42 of more than about two and one-half inches and less than about three inches. The fastening wall may be of a width of about two and one-half inches, or less, so that with many seats 16 it can be mounted as shown in FIG. 5 to create a finger grip notch 48.

When used in conjunction with a fastening wall 50, the shield wall 12 should be pre-configured into an arc so that the fastening wall 50 can lie smoothly against the seat bottom 30.

Similarly, when a fastening wall 50 is present, it is especially desirable that the fastening wall 50 be confirmed or conformable to the arc of the front of toilet seat 16 without introducing stress or memory that might urge the fastening wall 50 to return to another shape. Thus, the fastening wall 50 may be pre-formed into an arc similar to the preferred arc of the shield wall 12. As noted, such an arc may fall in the range of a two to six inch radius at the junction with the shield wall 12.

Usefully, the shield wall 12 and fastening wall 50 configured or treated to maintain the shield wall 12 in an arc while maintaining the major face of the fastening wall in a plane. Such means may include a selection of an appropriate component material and a treatment of the component material, which may include treatment selected from heat, pressure, tension, and compression. For example, the shield 10 may be formed from plastics without memory or plastics that can be permanently reshaped by heating, especially plastics that can be reshaped by heating with a hair dryer. The ability to heat the shield wall 12 and fastening wall 50 to remove memory or forming stress allows the shield 10 to be reconfigured into a new permanent shape. If desired, the shield wall 12 and fastening wall 50 initially to be provided in linear shape. Thus, it may be possible to produce the shield 10 by extrusion. Likewise, molding the shield 10 is a suitable method of production and is especially suitable when the shield 10 is manufactured in a pre-formed arc.

The embodiment of FIG. 4 provides a shield wall 12 integrally formed with a transverse fastening wall 52 that may or may not be of sufficient thickness to perform as bumper wall 46. A flexible, resilient cushion layer 54 is placed between fastening wall 52 and seat bottom 30 to both adhere the shield 10 to the seat 16 and to establish spacing between the seat 16 and the shield 10. The cushion layer 54 may be formed of a yieldable material such as a foam rubber or foam plastic. Adhesive faces on cushion layer 54 provide a means for variably mounting the shield 10. Variability is found both in the position of the shield 10 with respect to the width of the seat 16 and in the effective depth of the shield wall 12. Thus, for example, the shield 10 can be positioned for attachment further or nearer to rim 34 if so desired; or the shield can be positioned further or nearer to inside edge 42 of the seat 16, if so desired. This variable positioning allows creation of greater or smaller finger notch 48 and greater of smaller gap 20.

Applying a cushion layer 54 of selected thickness varies effective shield depth. Applying multiple layers 54 can increase the selected thickness to a desired dimension. As shown in FIG. 4, cushion layers 54 lower the fastening wall 52 with respect to seat bottom surface 30. With sufficient lowering, even the thin fastening wall 52 can be lowered to function as a bumper wall 46. The cushion layer 54 enables the fastening wall 52 to yield under pressure from rim surface 36. Thus, the yieldable nature of the cushion layer 54 allows the function of bumpers 38 on the seat 16 to be retained while also allowing wall 52 to function similarly to thicker wall 50 as a bumper wall 46. The fastening wall 52 need not be constructed with sufficient rigidity or hardness to fully support the seat 16 in place of a bumper 38.

Merger is possible between the embodiments of FIGS. 4 and 5. Different toilet seats 16 may be of different designs such that the gap 20 between toilet surface 36 and seat bottom 30 is not fully predictable. Thus, a shield 10 added as aftermarket supplement to a pre-existing seat 16 may or may not allow a substantial gap 20 between the seat 16 and the rim 34. The shield 10 provides an inside cover 12 over the gap 20 at the front quadrant of a toilet seat 16. The shield wall 12 is sufficient to deflect sprayed or splashed liquids from inside the toilet bowl 18 or from a seated, forward facing user.

The shield 10 of the invention is adaptable to substantially any toilet 14 and toilet seat 16 of the residential variety. In one embodiment, the shield 10 is attachable to seperately formed toilet seats 16 of FIGS. 4 and 5, which in another embodiment the shield is formed as a unitary part of a toilet seat 16 of FIG. 6. The addition of a fastening wall 50, 52 is optional, to increase the attachment area between a seat 16 and a shield 10. Likewise, the addition of a thick fastening wall 50 to serve as a bumper, bumper wall, or gap filler remains optional.

The foregoing is considered as illustrative only of the principles of the invention. Further, since numerous modifications and changes will readily occur to those skilled in the art, it is not desired to limit the invention to the exact construction and operation shown and described, and accordingly all suitable modifications and equivalents may be regarded as falling within the scope of the invention as defined by the claims that follow.

What is claimed is:

1. A toilet seat gap shield, comprising:
a shield wall configured as an arc;
a fastening wall connected to said shield wall, establishing a planar major face approximately perpendicular to the shield wall and substantially extending to only the convex side of the arc; and
means for attaching said fastening wall to a toilet seat.

2. The toilet seat gap shield of claim 1, further comprising:
a cushion layer applied to said fastening wall on the planar major surface thereof.

3. The toilet seat gap shield of claim 2, wherein:
said cushion layer further comprises a first adhesive face attaching the cushion layer to said fastening wall.

4. The toilet seat gap shield of claim 3, wherein:
said cushion layer further comprises a second adhesive face opposite said first adhesive face for attaching the cushion layer to a toilet seat.

5. The toilet seat gap shield of claim 1, wherein:
said shield wall is configured with an arc of radius in the range of two to eight inches.

6. In a toilet seat having a hinge at a rear end thereof and a seat ring at a front end thereof, defining a central opening within an inner edge of the seat ring, the improvement comprising:
a gap shield depending from the bottom of the seat ring at a front quadrant thereof.

7. The toilet seat of claim 6, wherein:
said gap shield depends from the bottom of the toilet seat in juxtaposition to the front inner edge of the seat ring.

8. The toilet seat of claim 6, wherein the hinge is oriented with respect to the seat ring to create a predetermined spacing between a bottom face of the seat ring and, in use, a top face of the toilet rim when both are disposed in parallel, wherein the improvement further comprises:
said gap shield is of a depth at least as great as said predetermined spacing, whereby the gap shield is suitably sized, in use, to cover the spacing.

9. The toilet seat of claim 8, wherein the improvement further comprises:
said gap shield is of a depth greater than said predetermined spacing, whereby the gap shield is suitably sized to cover the spacing.

10. The toilet seat of claim 6, further comprising:
a bumper wall extending forwardly from said gap shield and terminating before reaching an outer front of the seat ring, thereby providing a spacer defining a finger notch at the outer front of the seat ring and suited, in use, to separate the toilet seat ring from a toilet rim.

11. In combination, a toilet carrying a toilet seat mounted thereon, wherein the toilet defines an open topped bowl having a rim encircling the top opening of the bowl; the toilet seat includes a hinge attaching the seat to the toilet rearwardly of the bowl and further includes a seat ring extending from the hinge and defining a central opening bounded by an inner edge thereof, wherein the seat ring is selectively movable on the hinge to a position overlying the bowl rim, such that the central opening of the seat ring is aligned with the open top of the bowl; and further comprising:
a shield joined to the bottom of the seat ring and positioned juxtaposed to the front inner edge of the seat ring, in a position depending from the seat ring and covering a front inside portion of said bowl when the seat ring is in position overlying the bowl rim.

12. The combination of claim 11, wherein said shield comprises:
a shield wall configured in an arc and depending from said seat ring;
a fastening wall connected to said shield wall, having a planar major face extending from the shield wall substantially to only one side of the shield wall; and
means for attaching said fastening wall to the seat ring.

13. The combination of claim 12, wherein said fastening wall is of sufficient thickness to contact said rim when the seat ring is in said position overlying the bowl rim.

14. The combination of claim 13, wherein said fastening wall extends across the bottom face of the seat ring from said shield wall toward an outer edge of the seat ring and terminates short of said outer edge, thereby formed a finger notch between the seat ring and bowl rim.

15. The combination of claim 12, wherein:
the arc of said shield wall substantially matches the contour of said seat ring at the front inner edge thereof.

16. The combination of claim 11, wherein:
said shield and seat ring are formed as an integral unit.
